(19) United States
(12) Patent Application Publication
(10) Pub. No.: US 2003/0177696 A1
(43) Pub. Date: Sep. 25, 2003

(54) Stick-like packaging for flower substrates

(76) Inventor: Lars Zetterquist, Middlesex (GB)

Correspondence Address: WILDMAN, HARROLD, ALLEN & DIXON, 225 WEST WACKER DRIVE, CHICAGO, IL, 60606, US

(21) Appl. No.: 10/362,069

(22) PCT Filed: Apr. 6, 2001
(86) PCT No.: PCT/SE01/00778

(30) Foreign Application Priority Data
Aug. 21, 2000 (SE) 0002953-8

(51) Int. Cl. A01G 29/00

(52) U.S. Cl. 47/48.5

(57) ABSTRACT

A packaging for flower nutrients or flower food substrate. Said packaging is designed like a stick (1), to be used as a stirring device to dissolve its content in water for cut flowers kept in a vase. The dissolution of said nutrients is by use of said device forcefully enhanced in order to extend vase life-length of the flowers.

The present invention relates to a packaging for flower food or flower substrate.

In order to preserve quality of cut flowers and to extend vase life flower foods or flower substrates are commonly used.

Flower foods contain nutrients and other vase life extending and quality improving compounds. Usually these powder-like products are packed in dry state in small polyethylene sachets. The customer opens the sachets using scissors and empties the content in the vase water in which it dissolves slowly. In order to speed up this process usually one needs vigorous stirring and mixing with a spoon or by shaking the vase. This handling is considered by the consumer as inconvenient and prevents wider use of the flower foods. In mass merchandising channels the sachets cause inconvenience. They are usually added to the flowers in the packaging line by manual labour. This requires picking up of the bouquet or bunch and wrapping tape around the sachet and the bunch or adhering it to the sleeve, the plastic cover of the bouquet. Often the sachet is attached to the inside of the sleeve to prevent loss of the sachet during further handling or transport.

The sachets have content for 0.5 or 1 litre of vase water although often much larger volumes are used. The volume of the vase of choice relates to the size of the bouquet. Often the dosage is not correct and ineffective and to high dosage might even cause damage to the flowers. Sachets are attached to the packed bouquets or flower bunches with a tape that is wrapped around the stems. This is usually done in a packing line.

### PRIOR ART

The use of flower foods and nutrients is known per se and also elongated flower food containers have been described. There are two separate groups of prior art. One is the stirring containers, the second is the elongated flower food containers.

The Prior Art Described Distinctly Differ from our Invention:

Patent No. DE 3047700 A1 describes a product composed of pressed flower food chemicals shaped as a flower stem that can be packed in between flowers in a bunch and will dissolve or release its content when submerged in the vase water with the flowers. The flower stem shaped device can be applied as pressed material or as sachet. The foil of the sachet can be either water permeable or perforated. This is in fact a different product. The product can have a sachet or tube like appearance but differs in its application in that it is kept between the flowers and is submerged in the vase water. Our product is emptied in de water and disposed. The product as described will cause very high concentrations in its direct surrounding and especially at the bottom of the vase due to the slow and limited solubility of the compounds. Our product is meant to solve this problem by adding extra force to the process by stirring and dispersion of the particles enhancing the dissolution. The size and appearance will be quite different. The invention described in patent DE 3047700 A1 is meant to be as invisible as possible. Our invention in contrast is a clearly visible device that should attract customers.

Another invention described in Patent No. NL C 1001135 relates to a packaging for flower food comprising a long closed container for flower food as well as an extension at the end of the container that can be shortened to match the length of the stems of the flower bunch to which the packaging can be added. The container is a tube closed at both ends. Additionally extension peace can be part of the tube or mounted to the tube. This prior art describes a tube like container for flower food. The origin of the idea is to lower the packing cost at the flower packing stations. It mentions the ease of handling and the low cost for addition to the bunch in the packing process. It makes no reference to the stirring and dispersing function nor of any other advantages regarding application (length related dosage, attention function as a holder of information). Said art makes no reference to the shape of the heat seal. For our invention the heat seal should be shaped in such a way that it provides a flat or ribbed stirring surface and should be water tight but easily opened.

Patent NL C 1002643 describes a packaging for flower food of a sachet type as well as a process for production and simultaneous filling of such packaging. A packaging for plant (=flower) food comprising a sealed compartment that is protected to contain flower food and a second compartment free of plant food and a process for fully continuous forming and filling. This prior art is mainly aiming at lowering the costs for packing by preventing costs for mounting sachets to the sleeve of bouquets. It can be treated as a flower stem and added at the same cost as flower stems. The sachet as such is not stiff but acquires some strength due to the densely packed flower food. However, it cannot be used to stir after emptying this compartment. This prior art does not mention any application related functions such as stirring to facilitate dispensing and dissolution, length related dosage, easy opening or communication functions.

The patent in question describes a two-compartment container of which one is empty. This is needed to prevent loss of content when, after the sachet has been inserted between the flowers, the bunches are cut to the right size. We do not use a two-compartment system nor any form of extension. The container according to this prior art should have a volume to contain just the desired amount of flower food. No reference is made to the size of the sachet in relation to this amount. In fact it is common for flower food sachets that they contain a desired amount of flower food (for ½ litre or 1 litre). Filling a sachet to a fixed maximal content is easier than filling by stopping the flow of powder. This is rather a technological advantage, than an application related one. Also this prior art refers to the use of foils. In order to have sufficient tearing resistance a two layer foil is used. Preferably with a polyester second layer. These foils are expensive. Our invention makes use of single layer extruded commodity polymers and this is cheaper. Said prior art applies foil materials and seals these into a sachet. This is not comparable to our process that is filling end sealing of an extruded rod.

Both patents (NLC 100135 and 1002643) describe rod like containers that have been developed from a packaging technological perspective and the resulting products lack any product related or consumer-oriented properties. They both have an extension as an essential part, which is not required for the present invention.

Prior art concerning stirring containers are targeted to the markets of disposables and cutlery and the (fast) food market: coffee, tea and other drinks:

EP 0003390 A1 describes a stirring container.

GB 2257020 A describes a disposable spoon with condiment. It is heat sealed at one end only and at the other end it is closed by an edible and soluble sealer. This spoon is designed for drinks. Examples and corresponding drawings referred to in the claims are all related to the food market.

U.S. Pat. No. 005,866,185 A is an improvement of prior art by addition of a soluble coating over the perforations. This (group of) inventions relate to a stirring device for dissolving in an ingestible liquid, thus aiming at the food market.

G 90 02 3021 describes a limited food application of a stirring rod in this case for coffee cream (Kaffeesahne).

DE 2635417 A1 relates to food applications where Flavours or aromas are coated or pressed on a rod of about the size of a teaspoon (kaffeelöffellangen stäbchens).

DE 3841075 A1 describes a rod for food application. This product comprises one or more chambers that contain liquid or solid food components like sugar and milk to combine packaging function for these components and the stirring function of the spoon.

Japan 06244535: The rod is incorporated in the packaging and is not a packaging itself.

The above-mentioned patents relate to either stirring containers or flower food containers. The invention adds to the prior arts considerable novel dimensions as mentioned above.

According to the invention the packaging is designed like a stick, to be used as a stirring device to enhance the solution of a flower substrate, while dissolving its content in water for cut flowers kept in a vase, in order to extend vase life-length of the flowers.

The present invention solves the problem presented above by integrating several functional properties in the packaging and has in addition further advantages:

1. Ease of handling and attachment will reduce packaging costs.

2. The relatively stiff rod will allow stirring and thereby rapid dissolution of substrate.

3. The stick appears to be an ideal communication device.

4. The size of the stick allows easy dosage.

The stick according to the invention is in contrast to sachets easy to put in between the cut flowers in packed bouquets. In larger flower supply chains of mass merchandisers or supermarkets where flower bouquets are pre-packed in specialised packaging stations, the use of the stick will significantly reduce handling cost (labour costs) as it prevents the attachment of the sachets with tape to the bouquet or the packaging (sleeve).

The contents of the stick can be easily emptied in the water by gently squeezing at the seal and breaking the junction while at the same time the stick can be used as a stirring rod to add extra energy for the dissolution process. This property adds considerably to the perceived convenience of the product.

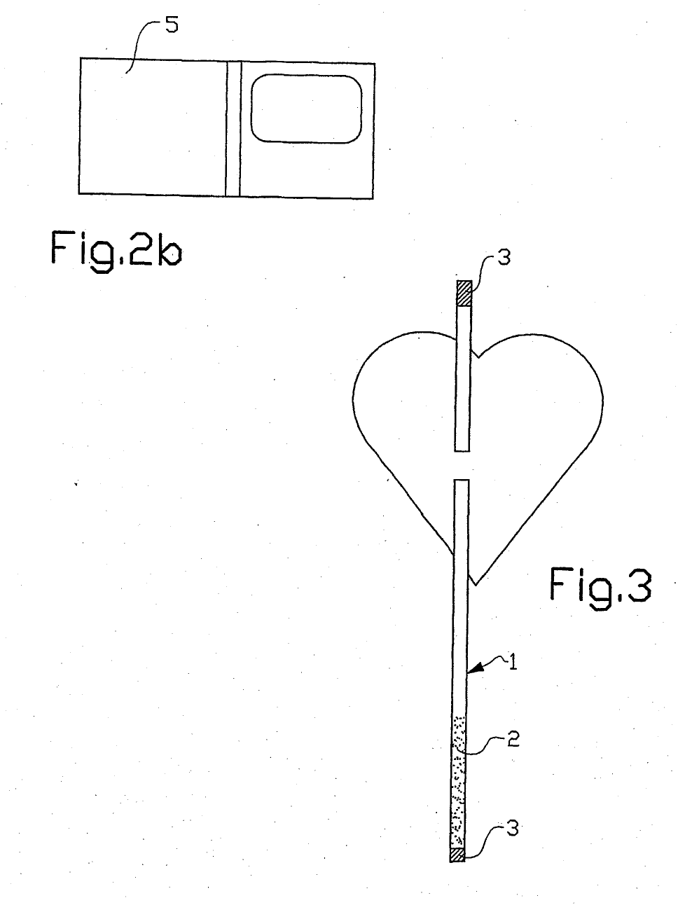

The stick protrudes slightly above the flowers of the bouquet and is clearly visible. It can therefore be used to draw attention of the consumers e.g. by using it for attachment of information and communication items or to give it an appealing (funny) design or to add (fun) articles. It could display brand labels or other advertisements, care instructions and other information for the consumer, bar codes and Tracking and tracing information and other information related to the quality management of the chain, and small (fun) articles like name tags, invitation cards, toy's, comic characters and other gimmicks. Also it could be designed as flag, traffic sign, magic stick, pencil, love arrow with a small heart (see FIG. 3), etc.

Since there is a relation between the size of the bouquet and the size of the vase chosen for it, the dosage of the flower food is more correct if the size of the bouquet is taken as the reference. The sticks can be made in various lengths and diameters, containing an amount of sugar that relates to the average and minimum volume of the vase taken by the customer for those size bouquets. This will prevent harmful over dosage of nutrients and other components.

Below the invention will be described more in detail with reference to one or more embodiments and accompanying drawings, where

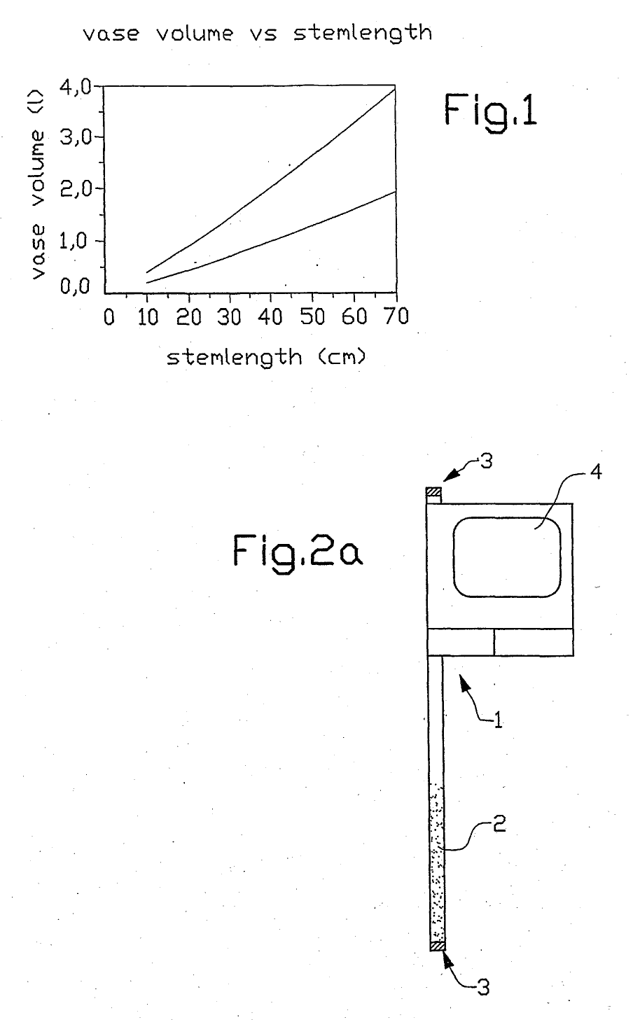

FIG. 1 shows the relationship between the length of the bouquet (stem length) and the vase volume chosen for, a particular bunch.,

FIG. 2a shows a specific example of package according to the invention,

FIG. 2b shows a foldable flyer to be attached to the stick, and

FIG. 3 shows another specific example like the one of FIG. 2.

According to the embodiment of FIG. 1 the amount of nutrients required optimally for a specific length can be derived from the average vase volume corresponding to that length. For flowers of 50 cm length, a volume is chosen between 1.0 and 2.5 litre. If the optimal sugar content of the vase water for the particular flowers is 10 grams per litre, the stick should contain 15 grams. If the flowers are sensitive to excess of biocide, one can determine the dosage of the biocide from the lower volume line. If a minimal content of a compound is required, one can calculate the dosage from the upper volume line.

It should be realised that this graph is only given as an example, this information appears to be more specific. Types of vases and volumes vary per type of flower or per country.

FIG. 2 shows polypropylene pipes of 50 cm and 0.6 cm diameter with wall thickness of 0.3 mm. In the embodiment according to FIG. 2, the pipes are filled with 15 gram sugar (sucrose) and were heat sealed at both ends with a ribbed sealing device to create a small flat stirring surface. An information leaflet (6 cm×12 cm, creased and folded in the middle) with consumer instructions about the use of the stick and with information on flower care in general, is attached to the sticks.

The sticks are used for pre-packed roses with an average stem length of 45 cm and with 10 roses per bunch and in pre packed mixed bouquets with an average length of 45 cm.

The sticks do not tear or break upon putting or pushing them between the flowers. In packing lines they can be handled like individual flowers and at the same cost, thereby reducing the packaging costs and speeding up the packaging process as compared to sachet attachment. The sticks cause no inconvenience and are not damaged during transportation.

In the display, the information leaflets are very clearly visible and have a nice appealing presence.

The sticks can be conveniently opened by gently squeezing the seal and breaking the junction. The chosen dimensions allow vigorous stirring without breaking or folding of the pipe due to its stiffness. The sugar thus released is easily dispersed and dissolves more rapidly due to the stirring action and stirring with the rod over the bottom of the vase The concentration of the sugar in the vase water appeared to be between 0.7 and 12 grams per litre, on average 10 grams per litre in the vases chosen for the flowers by (Dutch) consumers.

The Product

The invention is a stick like packaging 1 that can contain 4-20 grams of sugar or other nutrients 2 (for ca. 0.4-2 litres) in solid or liquid form. The length of the stick is preferably between 15 and 60 cm with a diameter of 0.4-1 cm. In order to obtain a sufficient stiffness, the wall thickness should be between 0.1 and 1 mm.

The stick has a cylindrical shape but can also be shaped as a beam or a spiral or as a spoon or a flower stem or any other long shape (not shown). Also In cross section it is circular or star-shaped with or without ribs to reinforce the stick and increase the stiffness and may have flights to improve the stirring properties.

The stick is made of any type of plastic e.g. commodity polymers polyethylene, polypropylene, polystyrene, or a biodegradable polymer like polylactic acid or a thermoplastic starch.

The stick is closed at both sides by a thermo seal 3 (heat seal) and/or a stopper. It can be opened by removing the stopper or squeezing the seal and breaking the junction.

The sticks should have sufficient overall stiffness in order to prevent breaking or kinking during stirring. This translates into a required minimal flexural modulus of the walls for each length of th stick. For polypropylene sticks with a diameter of 6 mm and a length of 10-30 cm a wall thickness 0.15-0.2 mm is enough. Sticks of 30-50 cm are preferably between 6 and 8 mm in diameter and require a wall thicknes exceeding 0.2 mm. Still longer sticks have preferably a wall thickness of at least 0.25 mm.

FIG. 3 shows polypropylene sticks of 40 cm and 0.6 cm diameter with wall thickness of 0.3 mm. In the embodiment according to FIG. 3, the pipes were filled with 15 gram sugar (sucrose) and were heat-sealed at one end with a ribbed sealing device to create a small flat stirring surface and closed with an arrowhead-shaped stopper at the other side. To the sticks a heart-shaped valentines card was attached with empty space for a message as well as consumer instructions about the use of the stick and flower care instructions.

The sticks are used for pre-packed roses with an average stem length of 40 cm and with 10 roses per bunch with an average length of 40 cm.

The sticks do not tear or break upon putting or pushing them between the flowers. In packing lines they can be handled like individual flowers and at the same cost, thereby reducing the packaging costs and speeding up the packaging process as compared to sachet attachment. The sticks cause no inconvenience and are not damaged during transportation.

In a display 4, information leaflets 5 are very clearly visible and have a nice appealing presence.

The sticks 1 can be conveniently opened by gently squeezing the seal and breaking the junction or removing the arrowhead. The chosen dimensions allow vigorous stirring without breaking or folding of the pipe due to its stiffness. The sugar thus released is easily dispersed and dissolves more rapidly due to the stirring action and stirring with the rod over the bottom of the vase.

The concentration of the sugar in the vase water on average became 9 grams per litre in the vases chosen for the flowers by consumers.

According to a third embodiment (no drawing) polypropylene sticks of 20 cm and 0.6 cm diameter with wall thickness of 0.3 mm are filled with 7 grams of sugar (sucrose), being heat sealed at one end with a heat-sealing device to create a small flat stirring surface on both sides. The sticks are to be used in pre-packed bouquets with an average stem length of 20 cm.

The concentration of the sugar in the vase water on average became 10 grams per litre in the vases chosen for the flowers by consumers.

1. A packaging for flower nutrients, flower food substrate, characterized in that it is designed like a stick (1), to be used as a stirring device to dissolving its content in water for cut flowers kept in a vase, in order to extend vase life-length of the flowers.

2. A product according to claim 1, characterized in that the stick formed packaging is to be put between the flowers where no means of attachment is needed.

3. A product according to claim 1, characterized in that the stick like packaging can serve as an attachment for information (4,5).

4. A product according to claim 1, characterized in that the stick-like packaging allows proper fore dosage of nutrients based on the length of the flowers.

5. A product according to claims 1-5, characterized in that it has a heat seal constituting a flat surface for stirring purposes.

6. A product according to claims 1-5, characterized in that it has a stopper as a flat surface for stirring.

7. A product according to claims 1-6, characterized in that it is between 15 and 60 cm long.

8. A product according to claims 7, characterized in that it is between 0,4-1 cm wide.

9. A product according to claim 8, characterized in that it contains 4-20 grams dry content.

10. A product according to claim 9, characterized in that it has a wall thickness of 0.1-1 mm.

11. A product according to anyone of the preceding claims, characterized in that it has a shape of a stick, a cylinder, a beam, a spiral, a spoon or a flower stem.

12. A product according to claim 9, characterized in that it has a circular or oval square, rectangular, star-shaped cross section.

13. A product according to anyone of the preceding claims, characterized in that it has reinforcements like ribs, flights or other details to improve strength or stirring properties.
